(19) United States
(12) Patent Application Publication
(10) Pub. No.: US 2023/0199805 A1
(43) Pub. Date: Jun. 22, 2023

(54) DATA TRANSMISSION METHOD AND APPARATUS, AND COMMUNICATIONS DEVICE

(71) Applicant: VIVO MOBILE COMMUNICATION CO., LTD., Dongguan (CN)

(72) Inventor: Jiamin LIU, Dongguan (CN)

(73) Assignee: VIVO MOBILE COMMUNICATION CO., LTD., Dongguan (CN)

(21) Appl. No.: 18/107,978

(22) Filed: Feb. 9, 2023

Related U.S. Application Data
(63) Continuation of application No. PCT/CN2021/111775, filed on Aug. 10, 2021.

(30) Foreign Application Priority Data
Aug. 14, 2020 (CN) 202010820552.2

(51) Int. Cl. H04W 72/30

(52) U.S. Cl. CPC H04W 72/30

(57) ABSTRACT

A data transmission method and apparatus, and a communications device are provided. When the data transmission method is applied to a terminal, the method includes: receiving configuration information of a target transmission mode of a multicast service; and continuously receiving service data based on the configuration information of the target transmission mode.

### CROSS-REFERENCE TO RELATED APPLICATIONS

This application is a continuation of International Application No. PCT/CN2021/111775, filed on Aug. 10, 2021, which claims priority to Chinese Patent Application No. 202010820552.2, filed on Aug. 14, 2020. The entire contents of each of the above-identified applications are expressly incorporated herein by reference.

### TECHNICAL FIELD

This application relates to the field of communications technologies, and specifically relates to a data transmission method and apparatus, and a communications device.

### BACKGROUND

Currently, Long Term Evolution (LTE) standardizes two multicast service transmission manners: Multimedia Broadcast multicast service Single Frequency Network (MBSFN) and Single Cell Point-To-Multipoint (SC-PTM), and the two transmission manners are both a mode on a Uu interface.

In a case that there are different terminals (User Equipment (UE)), a network side may dynamically select conversion between Point-To-Point (PTP) and Point To Multipoint (PTM) modes to maximize efficiency of system resources. However, in an existing switching process of the PTP and PTM modes, UE has problems of discontinuous service reception and impaired data quality.

### SUMMARY

Embodiments of this application aim to provide a data transmission method and apparatus, and a communications device.

According to a first aspect, a data transmission method is provided, applied to a terminal and including:

receiving configuration information of a target transmission mode of a multicast service; and

continuously receiving service data based on the configuration information of the target transmission mode.

According to a second aspect, a data transmission method is provided, applied to a network side device and including:

sending configuration information of a target transmission mode of a multicast service to a terminal, where

the configuration information is used to instruct the terminal to continuously receive service data based on the target transmission mode.

According to a third aspect, a data transmission apparatus is provided, applied to a terminal and including:

a first receiving module, configured to receive configuration information of a target transmission mode of a multicast service; and

a second receiving module, configured to continuously receive service data based on the configuration information of the target transmission mode.

According to a fourth aspect, a data transmission apparatus is provided, applied to a network side device and including:

a sending module, configured to send configuration information of a target transmission mode of a multicast service to a terminal, where

the configuration information is used to instruct the terminal to continuously receive service data based on the target transmission mode.

According to a fifth aspect, a communications device is provided, including a processor, a memory, and a program or an instruction that is stored in the memory and that can be run on the processor, where when the program or the instruction is executed by the processor, the steps of the data transmission method in the first aspect are implemented, or the steps of the data transmission method in the second aspect are implemented.

According to a sixth aspect, a readable storage medium is provided. The readable storage medium stores a program or an instruction, and when the program or the instruction is executed by a processor, the steps of the data transmission method in the first aspect are implemented, or the steps of the data transmission method in the second aspect are implemented.

According to a seventh aspect, a chip is provided. The chip includes a processor and a communications interface, the communications interface is coupled to the processor, and the processor is configured to run a program or an instruction of a network side device to implement the method in the first aspect or the method in the second aspect.

According to an eighth aspect, a computer program product is provided. The program product is stored in a non-volatile storage medium, and the program product is executed by at least one processor to implement the method in the first aspect or the method in the second aspect.

### BRIEF DESCRIPTION OF DRAWINGS

FIG. 1 is a block diagram of a wireless communications system to which embodiments of this application can be applied;

FIG. 2 is a flowchart of a data transmission method according to an embodiment of this application;

FIG. 3 is a flowchart of another data transmission method according to an embodiment of this application;

FIG. 4 is a structural diagram of a data transmission apparatus according to an embodiment of this application;

FIG. 5 is a structural diagram of another data transmission apparatus according to an embodiment of this application;

FIG. 6 is a structural diagram of a communications device according to an embodiment of this application;

FIG. 7 is a structural diagram of a terminal according to an embodiment of this application; and

FIG. 8 is a structural diagram of a network side device according to an embodiment of this application.

### DETAILED DESCRIPTION

The following describes the embodiments of this application with reference to the accompanying drawings in the embodiments of this application. Apparently, the described embodiments are some but not all of the embodiments of this application. All other embodiments obtained by a person of ordinary skill in the art based on the embodiments of this application without creative efforts shall fall within the protection scope of this application.

In the specification and claims of this application, the terms “first,” “second,” and the like are intended to distinguish between similar objects but do not describe a specific order or sequence. It should be understood that, data termed in such a way is interchangeable in proper circumstances, so that the embodiments of this application can be implemented in an order other than the order illustrated or described herein. Objects classified by “first” and “second” are usually of a same type, and the number of objects is not limited. For example, there may be one or more first objects. In addition, in the specification and the claims, “and/or” represents at least one of connected objects, and a character “/” generally represents an “or” relationship between associated objects.

It should be noted that, the technologies described in the embodiments of this application are not limited to a Long Term Evolution (LTE)/LTE-Advanced (LTE-A) system, and. can also be used in other wireless communications systems such as Code Division Multiple Access (CDMA), Time Division Multiple Access (TDMA), Frequency Division Multiple Access (FDMA), Orthogonal Frequency Division Multiple Access (OFDMA), Single-Cartier Frequency-Division Multiple Access (SC-FDMA), and another system. The terms “system” and “network” in the embodiments of this application may be used interchangeably. The technologies described can be applied to both the systems and the radio technologies mentioned above as well as to other systems and radio technologies. However, the following descriptions describe a New Radio (NR) system for example purposes, and NR terms are used in most of the following descriptions, although these technologies can also be applied to an application other than an NR system application, for example, a 6^{th} Generation (6G) communications system.

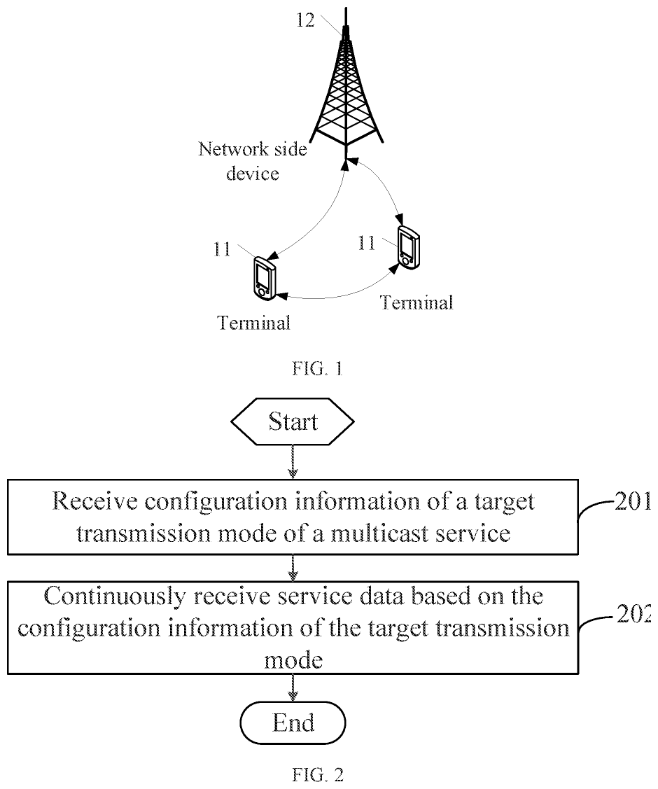

FIG. 1 is a block diagram of a wireless communications system to which embodiments of this application can be applied. The wireless communications system includes a terminal 11 and a network side device 12. The terminal 11 may also be referred to as a terminal device or User Equipment (UE). The terminal 11 may be a terminal side device such as a mobile phone, a tablet personal computer, a laptop computer or a notebook computer, a Personal Digital Assistant (PDA), a palmtop computer, a netbook, an Ultra-Mobile Personal Computer (UMPC), a Mobile Internet Device (MID), a wearable device, Vehicle User Equipment (VUE), or Pedestrian User Equipment (PUE). The wearable device includes a bracelet, a headset, glasses, and the like. It should be noted that a specific type of the terminal 11 is not limited in the embodiments of this application. The network side device 12 may be a base station or a core network. The base station may be referred to as a NodeB, an evolved NodeB, an access point, a Base Transceiver Station (BTS), a radio base station, a radio transceiver, a Basic Service Set (BSS), an Extended Service Set (ESS), a NodeB, an evolved NodeB (eNB), a home NodeB, a home evolved NodeB, a WLAN access point, a Wi-Fi node, a Transmitting Receiving Point (TRP), or another appropriate term in the art. As long as a same technical effect is achieved, the base station is not limited to a specified technical term. It should be noted that, in the embodiments of this application, only a base station in an NR system is used as an example, but a specific type of the base station is not limited.

With reference to the accompanying drawings, the data transmission method provided in the embodiments of this application is described in detail by using specific embodiments and application scenarios.

Referring to FIG. 2, FIG. 2 is a flowchart of a data transmission method according to an embodiment of this application. The data transmission method is applied to a terminal. As shown in FIG. 2, the data transmission method includes the following steps:

Step 201: Receive configuration information of a target transmission mode of a multicast service.

In this embodiment of this application, the target transmission mode may include a Point-To-Point (PTP) transmission mode and a Point To Multipoint (PTM) transmission mode.

In some implementations, the configuration information may be used for a scenario in which a transmission mode is reconfigured due to cell switching. For example, in a case that the terminal performs cell switching, the configuration information instructs the terminal to switch from a source transmission mode of a source cell to a target transmission mode of a target cell, or instruct the terminal to switch from a source transmission mode to a target transmission mode in a current cell in a case the terminal is in a same cell.

It should be noted that the source transmission mode may also include a PTP transmission mode and a PTM transmission mode. Transmission mode switching may include the following several scenarios: switching from the PTP transmission mode to the PTM transmission mode, switching from the PTM transmission mode to the PTM transmission mode, switching from the PTP transmission mode to the PTP transmission mode, and switching from the PTM transmission mode to the PTM transmission mode.

In some implementations, transmission mode switching may occur between different cells, between different base stations, or within a same cell. For example, when the terminal is switched from the source cell to the target cell, and the terminal accesses the target cell, the terminal may be switched from a PTP transmission mode of the source cell to a PTM transmission mode of the target cell. In some implementations, the source cell and the target cell may be a same cell, and therefore, switching of a cell transmission mode occurs in the same cell.

In this embodiment of this application, the configuration information may be sent by a network side device to the terminal. For example, the configuration information may be a System Information Block (SIB) or dedicated signaling sent by the network side device, to instruct the terminal to continuously receive multicast service data in the target transmission mode.

Step 202: Continuously receive service data based on the configuration information of the target transmission mode.

It can be understood that, when receiving the configuration information, the terminal continuously receives the service data based on the target transmission mode.

In this embodiment of this application, a terminal can determine a target transmission mode based on configuration information, and then continuously receive multicast service data based on the target transmission mode, to ensure continuity of service data received by the terminal in the target transmission mode, and avoid impaired data quality caused by discontinuity of service data reception, thereby improving quality of data transmission between a network side device and the terminal.

It can be understood that the target transmission mode is a PTP transmission mode or a PTM transmission mode, and the source transmission mode may also be a PTP transmission mode or a PTM transmission mode. In this embodiment of this application, switching from the source transmission mode to the target transmission mode may also include four different switching scenarios. In different switching scenarios, the terminal may continuously receive service data through different means.

In a case that the target transmission mode is a PTM transmission mode, the continuously receiving service data includes any one of the following:

receiving first assistance information sent by a network side device based on a Control Plane (CP) or a User Plane (UP), and receiving and reordering the service data based on the first assistance information, where the assistance information is used to indicate a correspondence between a Sequence Number (SN) of a source transmission mode and an SN of the target transmission mode;

obtaining explicit or implicit first indication information, and establishing a multicast bearer from an SN initialization state based on the first indication information to continuously receive the service data;

obtaining explicit or implicit second indication information, and establishing a multicast bearer from an SN hold state based on the second indication information to continuously receive the service data; and

establishing an associated unicast bearer, and continuously receiving the service data based on the associated unicast bearer.

In the foregoing four implementations, the corresponding source transmission mode may be a PTM transmission mode, or may be a PTP transmission mode. The foregoing four implementations are specifically described below.

In a first implementation, there may be a specific correspondence between the SN of the source transmission mode and the SN of the target transmission mode. In this case, the terminal receives the first assistance information that is sent by the network side device based on the CP or the UP and that is used to indicate a deviation, and then can receive and reorder the service data based on the first assistance information, to continuously receive the service data.

It can be understood that strict synchronization is specified (that is, it is required that a same Layer 2 (L2) SN of an air interface is allocated to a same data packet by a neighboring cell). For example, a cell 1 first joins a multicast group, and allocates a Packet Data Convergence Protocol (PDCP) SN, for example, PDCP SN=0, to a data packet of a General Packet Radio Service (GPRS) Tunnel Protocol (GTP), for example, GTP-U SN=100. Then a cell 2 joins the multicast group, and allocates PDCP SN=0 to a data packet of GTP-U SN=500. In this case, L2 SNs allocated to a same data packet by the two cells are deviated, and this deviation may be notified to the UE for reordering. In some implementations, the premise is that an interface between the two cells notifies each other of an L2 SN allocation manner and calculates the deviation. For example, the interface receives information about a source cell. If the source cell allocates PDCP SN=400 to a data packet whose service allocation manner of a specific Temporary Mobile Group Identifier (TMGI) is GTP-U SN=500, and a target cell allocates PDCP SN=0 to the data packet of GTP-U SN=500, the UE may be notified by using dedicated signaling or a SIB that a deviation of L2 SNs between the target cell and the source cell is 400 (it is assumed that a difference is defined as SN of the source cell−SN of the target cell), or may be notified that a deviation is −400 (it is assumed that a difference is defined as SN of the target cell−SN of the source cell). After obtaining information about the deviation, the UE may continuously receive and reorder data. For example, after the UE receives a data packet of L2 SN=8 in the source cell, and learns that the SN deviation is 400 after being switched to or re-selected to the target cell, in this case, the received L2 SN of the target cell=407, 408, 409 . . . , so that it can be learned that the first two are duplicated packets, and may be deleted and reordered, to ensure continuity of service data reception.

It should be noted that, in a case that the first assistance information is sent based on the UP, the first assistance information is carried in a Layer 2 (L2) control Protocol Data Unit (PDU) or an L2 PDU header, for example, a PDCP PDU or a PDCP control PDU.

In a second implementation, if the network side device does not configure configuration information indicating whether an SN state of the source transmission mode and an SN state the target transmission mode are maintained, and does not configure the first assistance information indicating a deviation between the SN of the source transmission mode and the SN of the target transmission mode, the terminal may obtain the explicit or implicit first indication information, where the first indication information is used to instruct the terminal to establish the multicast bearer from the SN initialization state based on the first indication information, to continuously receive the service data. For example, before the UE switches to a PTM transmission mode, a data packet to of L2 SN=89 has been sent in the source transmission mode. After the UE switches to the target transmission mode, the network side device continues to send a next data packet but numbers an L2 SN of the next data packet from 0 again, and sequentially numbers subsequently received data packets.

In a third implementation, the terminal may further establish the multicast bearer from the SN hold state based on the received second indication information, to continuously receive the service data. For example, before the UE switches to a PTM transmission mode, a data packet to of L2 SN=89 has been sent in the source transmission mode. After the UE switches to the target transmission mode, a base station continues to send a data packet of L2 SN=90. The terminal maintains an SN state of the data packet unchanged, that is, the data packet still corresponds to L2 SN=90. Similarly, an SN state of a subsequently received data packet remains unchanged.

In a fourth implementation, the terminal may further establish the associated unicast bearer, and continuously receive the service data based on the associated unicast bearer. It can be understood that, because the target transmission mode is a PTM transmission mode, the service data is sent to a plurality of UEs. When there is newly added UE, adjustment of a transmission mode affects other UEs, and then an associated unicast bearer may be established to transit service data for the newly added UE.

The establishing an associated unicast bearer may include:

in a case that the source transmission mode is switched to the target transmission mode, establishing the associated unicast bearer based on third indication information, where the third. indication information is used to indicate a target service for which the associated unicast bearer needs to be established.

For example, in a case that the terminal switches from the PTM transmission mode to the PTM transmission mode or from the PTP transmission mode to the PTM transmission mode, the associated unicast bearer may be established based on the third indication information, and the third indication information may be sent by the network side device and is used to indicate that a service for which the associated unicast bearer needs to be established. For example, for UE that switches a transmission mode, a cell corresponding to the source transmission mode may carry a service and reception of interest to the UE in an interface switching request message, for example, an interested TMGI list. After receiving interface switching request information, a cell corresponding to the target transmission mode may select, according to the interested TMGI list, a service that needs lossless guarantee, and establish an associated unicast bearer for the UE. For example, if there are five interested services, but only two of the services have lossless requirements, the two services are target services, and associated unicast bearers may be established for the two services. For example, a Data Radio Bearer (DRB) x corresponds to a lossless requirement TMGI 1, and a DRB y corresponds to a lossless requirement TMGI 2. The information is then carried in a switching command to be returned to the cell corresponding to the source transmission mode, and a base station in the cell may send the second indication information to the UE to instruct the UE to establish associated unicast bearers DRB x and DRB y.

In some implementations, the terminal may establish the associated unicast bearer in a case that sending in the source transmission mode is not synchronized with sending the target transmission mode. For example, the associated unicast bearer may be established in a case that sending in the source transmission mode is slower than sending in the target transmission mode, so as to compensate for data sending; or the associated unicast bearer may be established in a case that sending in the source transmission mode is faster than sending in the target transmission mode, to interact with the UP in an SN reception state, so that the UE performs duplicate detection on received service data. For example, when a data packet received by the UE based on the target transmission mode is the same a data packet received based on the source transmission mode, the same data packet received in the target transmission mode may be deleted.

Further, the continuously receiving the service data based on the associated unicast bearer includes at least one of the following:

sending service reception state information to a cell corresponding to the target transmission mode by using the associated unicast bearer;

receiving target data sent by the cell corresponding to the target transmission mode, and reordering the target data and received data; and

receiving a target SN mapping relationship sent by the cell corresponding to the target transmission mode, and receiving and reordering the service data based on the target SN mapping relationship, where the target SN mapping relationship is a mapping relationship between the SN of the source transmission mode and the SN of the target transmission mode.

To better understand a solution of how to establish the associated unicast bearer and continuously receive the service data based on the associated unicast bearer, the following uses several specific embodiments as examples for description.

### Embodiment 1

Step 1: For UE that switches a transmission mode, the cell corresponding to the source transmission mode may carry a service and reception of interest to the UE in an interface switching request message, for example, an interested TMGI list. After receiving interface switching request information, the cell corresponding to the target transmission mode may select, according to the interested TMGI list, a service that needs lossless guarantee, and establish an associated unicast bearer for the UE. For example, if there are five interested services, but only two of the services have lossless requirements, associated unicast bearers may be established for the two services. For example, a DRB x corresponds to a lossless requirement TMGI 1, and a DRB y corresponds to a lossless requirement TMGI 2. The information is then carried in a switching command to be returned to the cell corresponding to the source transmission mode.

Step 2: The cell corresponding to the source transmission mode sends the switching command to the UE.

Step 3: The UE accesses the cell corresponding to the target transmission mode and establish associated unicast bearers DRB x and DRB y based on the switching command, where the DRB x corresponds to the lossless requirement TMGI 1, and the DRB y corresponds to the lossless requirement TMGI 2

Step 4: The UE sends reception state information of a corresponding multicast service by using the associated unicast bearer. For example, reception state information of the TMGI 1 is sent by using the DRB x, received data of GTP-U SN=100 or received data of PDCP SN=10 in the TMGI 1 is sent by using the TMGI 1, and the state information is sent to the cell corresponding to the target transmission mode.

Step 5: The cell corresponding to the target transmission mode receives the state information, and performs compensation sending on data according to a reception state of the UE. For example, the state information indicates that the UE has received the data of GTP-U SN=100 based on the source transmission mode. When performing mode switching, the UE fails to receive data of GTP-U SN=100 and 101, and after switching to the target transmission mode, the corresponding cell may perform compensation sending on the data of GTP-U SN=100 and 101.

### Embodiment 2

Step 1: The LE establishes the associated unicast bearer in a case that sending in the source transmission mode is slower than sending in the target transmission mode, or may establish the associated unicast bearer in a case that sending in the source transmission mode is faster than sending in the target transmission mode.

Step 2: The UE sends reception state information of a corresponding multicast service by using the established associated unicast bearer. For example, reception state information of the TMGI 1 is sent by using the DRB x, received data of GTP-U SN=100 or received data of PDCP SN=10 in the TMGI 1 is sent by using the TMGI 1, and the state information is sent to the cell corresponding to the target transmission mode.

Step 3: The cell corresponding to the target transmission mode receives the state information, and performs compensation sending on data according to a reception state of the UE.

In some implementations, SN mapping information may be carried by using dedicated signaling, to ensure that the terminal continuously receives service data.

### Embodiment 3

Step 1: For UE that switches a transmission mode, after the cell corresponding to the target transmission mode receives interface switching request information, the mapping relationship between the SN of the source transmission mode and the SN of the target transmission mode may be carried in a switching command to be returned to the cell corresponding to the source transmission mode.

Step 2: The cell corresponding to the source transmission mode sends the switching command to the UE.

The Step 3: The UE obtains the mapping relationship between the SN of the source transmission mode and the SN of the target transmission mode based on the switching command, establishes an association relationship between the source transmission mode and the target transmission mode, and then reorders data received based on the target transmission mode and data received based on the source transmission mode, and submits the data in order.

In this embodiment of this application, when the target transmission mode is a PTM transmission mode, and the source transmission mode is also a PTM transmission mode, the continuously receiving service data further includes:

in a case that an SN state of the source transmission mode is the same as an SN state of the target transmission mode, establishing a multicast bearer based on the target transmission mode, maintaining the SN state of the target transmission mode the same as the SN state of the source transmission mode, and continuously receiving the service data.

In this implementation, when the terminal switches from the PTM transmission mode to the PTM transmission mode, if the SN of the source transmission mode is the same as the SN of the target transmission mode, the multicast bearer is established in the target cell. The network side device sends configuration information to the terminal to indicate that the SN state of the target transmission mode maintains the same as the SN state of the source transmission mode, and the terminal can also determine, based on the configuration information, that the SN state of the target transmission mode maintains the same as the SN state of the source transmission mode, to continuously receive the service data.

It can be understood that a multicast channel from a core network to a base station is totally the same for each cell, that is, when data of the core network is sent to each base station, an SN identifier of an interface used by a same service data packet is the same. For example, for a sequence number GTP-U SN of an GTP-U of an Xn interface, content of a data packet of GTP-U SN=100 sent to a cell 1 is exactly the same as that of a data packet of GTP-U SN=100 sent to a cell 2. In this way, if the cell 1 allocates a PDCP SN=0 to the data packet of GTP-U SN=100 for air interface multicast sending, the cell 1 sends mapping information of the SN to the cell 2 by using the Xn interface, and the cell 2 allocates the same PDCP SN=0 to the same data packet of GTP-U SN=100 during air interface multicast sending. In this way, data packet labels of neighboring cells are the same, thereby greatly improving reception continuity and a lossless probability of the UE. The cell 1 may be a source cell, and the cell 2 may be a target cell. For example, the UE receives data PDCP SN=100 corresponding to a TMGI in the source cell. When switching or moving to the target cell, the UE continues to receive data of the PDCP SN=99, 100, 101, 102 . . . , and the UE may learn that 99 and 100 are duplicate data and may be deleted. In this way, service data can be continuously received.

In addition, it should be noted that, to ensure that the terminal continuously receives service data, in a case that the transmission mode of the UE is switched between different cells, the network side device may further set a specific period for different cells, for example, a service period or a service change period.

In this embodiment of this application, the target transmission mode may be a PTP transmission mode, and the source transmission mode may be a PTP transmission mode or a PTM transmission mode. In a case that the target transmission mode may be a PTP transmission mode, and the source transmission mode is a PTM transmission mode, the continuously receiving service data includes:

establishing a unicast bearer, and receiving multicast service data based on the unicast bearer, where an SN state of service data received in the target transmission mode is maintained based on an SN state of service data received in a source transmission mode; or

establishing an initialized unicast bearer, and receiving multicast service data based on the initialized unicast bearer, where an SN of service data received based on the target transmission mode is an initialized SN.

It can be understood that switching from the PTM transmission mode to the PTP transmission mode is switching from multi cast transmission to unicast transmission. In a first implementation, the terminal establishes a unicast bearer, and continuously receives multicast service data based on the unicast bearer. For example, before the UE switches to a PTP transmission mode, a data packet to of L2 SN=89 has been sent in the source transmission mode. After the UE switches to the PTP transmission mode, the base station continues to send a data packet of L2 SN=90 on a PTP bearer. The terminal maintains an SN state of an existing data packet unchanged. That is, after receiving the data packet, the terminal sorts the data packets of SN=89 and SN=90. Similarly, subsequently received data packets are sorted according to SNs.

In some implementations, in a second implementation, the UE establishes an initialized unicast bearer, and receives multicast service data based on the initialized unicast bearer. In this implementation, an SN of service data received by the UE based on a PTP transmission mode is an initialized SN. For example, before the UE switches to the PTP transmission mode, a data packet to of L2 SN=89 has been sent in the source transmission mode. After the UE switches to the PTP transmission mode, the base station continues to send a next data packet. However, the target node reorders an L2 SN from zero, that is, an L2 SN of a received new data packet, so that a data packet of L2 SN=90 received by the terminal based on the source transmission mode is actually consistent with a data packet of L2 SN=0 received in the target transmission mode.

In some implementations, in a case that an SN state of service data received in the target transmission mode is maintained based on an SN state of service data received in a source transmission mode, the method further includes:

reporting SN state information of service data received based on the unicast bearer, where the SN state information includes at least one of service data that is successfully received and service data that fails to be received on the unicast bearer.

It can be understood that, in a case that an SN state is maintained, service data received by the terminal may be successfully received, or may fail to be received. The terminal may report the SN state information of the received service data to the network side, so that the network side can learn which sent service data is successfully received by the terminal, and which service data fails to be received, and then the network side can retransmit the service data that fails to be received.

Further, in a case that the SN state information includes the service data that fails to be received on the unicast bearer, the method further includes:

receiving second target data that is sent by the network side device in response to the SN state information, where the second target data is unicast service data that fails to be received on the unicast bearer.

It can be understood that, after receiving the SN state information reported by the terminal, the network side device can retransmit the service data that fails to be received by the terminal, thereby ensuring that the terminal can continuously receive service data and avoiding a loss of the service data.

In some implementations, after the receiving target data that is sent by the network side device in response to the SN state information, the method further includes:

reordering the received target data and received service data.

It can be understood that the target data retransmitted by the network side device may not be sent in order, and therefore the terminal reorders the received target data and the received service data. For example, if the service data received by the terminal includes data packets of L2 SN=88, 90, 91, and 92, a data packet of L2 SN=89 fails to be received. The terminal may report, to the network side device, SN state information of the service data that fails to be received, and the network side device retransmits the data packet of L2 SN=89. Because the terminal has already received the data packets of L2 SN=88, 90, 91, and 92, the terminal reorders the received data packet of L2 SN=89 and the received data packets, to ensure continuity of data reception of the terminal.

It should be noted that, in a case that the terminal does not report the SN state information, the network side device may also retransmit data to the terminal. For example, when a data packet of L2 SN=258 has been sent based on the source transmission mode, the terminal is switched to the PTP transmission mode, to ensure that the last several data packets can also be received. Data packets of L2 SN=256, 257, and 258 may be retransmitted based on the PTP transmission mode. If the UE fails to receive data packets of 256 and 257, compensation for a reception gap may be performed. If the UE successfully receives the data packets of 256 and 257 earlier, the data packets are directly deleted as duplicated data. In this way, it can be ensured that the terminal can continuously receive data, thereby avoiding a data loss and ensuring lossless data.

According to the solution provided in this embodiment of this application, a terminal can determine a target transmission mode based on configuration information, and then continuously receive multicast service data based on the target transmission mode, to ensure continuity of service data received by the terminal in the target transmission mode, and avoid impaired data quality caused by discontinuity of service data reception, so that a network side device can perform Multicast and Broadcast Service (MBS) service transmission in a more efficient manner, thereby improving data transmission efficiency of a communications system.

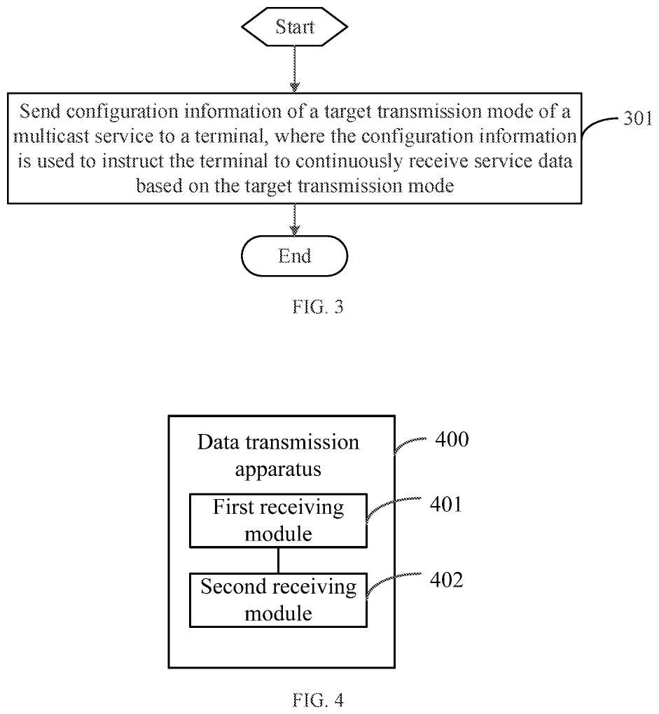

Referring to FIG. 3, FIG. 3 is a flowchart of another data transmission method according to an embodiment of this application. The data transmission method is applied to a network side device. As shown in FIG. 3, the data transmission method includes the following steps:

Step 301: Send configuration information of a target transmission mode of a multicast service to a terminal, where the configuration information is used to instruct the terminal to continuously receive service data based on the target transmission mode.

In this embodiment of this application, the target transmission mode may include a PTP transmission mode and a PTM transmission mode.

In some implementations, transmission mode switching may occur between different cells, between different base stations, or within a same cell. The configuration information is used to indicate that the terminal is currently switched to the target transmission mode. For example, in a case that the terminal performs cell switching, the configuration information may instruct to switch from a source transmission mode of a source cell to a target transmission mode of a target cell, or may instruct the terminal to switch from a source transmission mode to a target transmission mode in a same cell.

It should be noted that the source transmission mode may also include a PTP transmission mode and a PTM transmission mode. Transmission mode switching may include the following several scenarios: switching from the PTP transmission mode to the PTM transmission mode, switching from the PTM transmission mode to the PTM transmission mode, switching from the PTP transmission mode to the PTP transmission mode, and switching from the PTM transmission mode to the PTM transmission mode.

In this embodiment of this application, a network side device sends configuration information of a target transmission mode of a multicast service to a terminal, so that the terminal can determine the target transmission mode based on the configuration information, and continuously receive multicast service data based on the target, transmission mode, to ensure continuity of service data received by the terminal in the target transmission mode, and avoid impaired data quality caused by discontinuity of service data reception, thereby improving quality of data transmission between the network side device and the terminal.

In some implementations, in a case that the target transmission mode is a point-to-multipoint PTM transmission mode, the method further includes any one of the following:

sending first assistance information to the terminal based on a CP or a UP, where the first assistance information is used to indicate a correspondence between an SN of a source transmission mode and an SN of the target transmission mode;

sending explicit or implicit first indication information, where the first indication information is used to instruct the terminal to establish a multicast bearer from an SN initialization state to continuously receive the service data;

sending explicit or implicit second indication information, where the second indication information is used to instruct the terminal to establish a multicast bearer from an SN hold state to continuously receive the service data; and

sending third indication information, where the third indication information is used to instruct the terminal to establish an associated unicast bearer.

It should be noted that, in the foregoing four implementations, the corresponding source transmission mode may be a PTM transmission mode, or may be a PTP transmission mode.

In a first implementation, the network side device sends the first assistance information to the terminal, so that the terminal can learn the correspondence between the SN of the source transmission mode and the SN of the target transmission mode based on the first assistance information, to ensure that in the case of switching to the target transmission mode, the terminal can sort received service data based on the correspondence, thereby implementing continuity of service data reception.

In a case that the first assistance information is sent based on the UP, the first assistance information is carried in a L2 control PDU or an L2 PDU header.

It can be understood that strict synchronization is specified (that is, it is required that a same L2 SN of an air interface is allocated to a same data packet by a neighboring cell). For example, a cell 1 first joins a multicast group, and allocates PDCP SN=0 to a data packet of GTP-U SN=100. Then a cell 2 joins the multicast group, and allocates PDCP SN=0 to a data packet of GTP-U SN=500. In this case, L2 SNs allocated to a same data packet by the two cells are deviated, and this deviation may be notified to the UE for reordering. In some implementations, the premise is that an interface between the two cells notifies each other of an L2 SN allocation manner and calculates the deviation. For example, the interface receives information about a source cell. If the source cell allocates PDCP SN=400 to a data packet whose service allocation manner of a specific TMGI is GTP-U SN=500, and a target cell allocates PDCP SN=0 to the data packet of GTP-U SN=500, the UE may be notified by using dedicated signaling or a SIB that a deviation of L2 SNs between the target cell and the source cell is 400 (it is assumed that a difference is defined as SN of the source cell−SN of the target cell), or may be notified that a deviation is −400 (it is assumed that a difference is defined as SN of the target cell−SN of the source cell). After obtaining information about the deviation, the UE may continuously receive and reorder data. For example, after the LTE receives a data packet of L2 SN=8 in the source cell, and learns that the SN deviation is 400 after being switched to or re-selected to the target cell. In this case, the received L2 SN of the target cell=407, 408, 409 . . . , so that it can be learned that the first two are duplicated packets, and may be deleted and reordered, to ensure continuity of service data reception.

In a second implementation, if the network side device does not configure configuration information indicating whether an SN state of the source transmission mode and an SN state the target transmission mode are maintained, and does not configure the first assistance information indicating the correspondence between the SN of the source transmission mode and the SN of the target transmission mode, the network side device sends the explicit or implicit first indication information, where the first indication information is used to notify the terminal that both the configuration information and the first assistance information are not configured, and the terminal establishes the multicast bearer from the SN initialization state based on the first indication information, to continuously receive the service data. For example, before the UE switches to a PTM transmission mode, a data packet to of L2 SN=89 has been sent in the source transmission mode. After the UE switches to the target transmission mode, the network side device continues to send a next data packet and numbers an L2 SN of the data packet from 0 again, and sequentially numbers subsequently received data packets.

In a third implementation, the terminal may further establish the multicast bearer from the SN hold state based on the received second indication information, to continuously receive the service data. For example, before UE switches to a PTM transmission mode, a data packet to of L2 SN=89 has been sent in the source transmission mode. After the UE switches to the target transmission mode, the network side device continues to send a data packet of L2 SN=90. The terminal maintains an SN state of the data packet unchanged, that is, the data packet still corresponds to L2 SN=90. Similarly, an SN state of a subsequently received data packet remains unchanged.

In a fourth implementation, the network side device may further instruct the terminal to establish the associated unicast bearer. It can be understood that, because the target transmission mode is a PTM transmission mode, the service data is sent to a plurality of UEs. When there is newly added UE, adjustment of a transmission mode affects other UEs, and then the terminal may be instructed to establish an associated unicast bearer to transmit service data for the newly added UE.

The third indication information includes at least one of the following:

a target service for which the associated unicast bearer needs to be established;

an SN difference between an SN of service data in the source transmission mode and an SN of service data in the target transmission mode; and

configuration information of the associated unicast bearer.

For example, for UE that switches a transmission mode, a cell corresponding to the source transmission mode may carry a service and reception of interest to the UE in an interface switching request message, for example, an interested TMGI list. After receiving interface switching request information, a cell corresponding to the target transmission mode may select, according to the interested TMGI list, a service that needs lossless guarantee, and establish an associated unicast bearer for the UE. For example, if there are five interested services, but only two of the services have lossless requirements, the two services are target services, and associated unicast bearers may be established for the two services.

In some implementations, the third indication information sent by the network side device may further carry the SN difference between the SN of the service data in the source transmission mode and the SN of the service data in the target transmission mode, so that the terminal can sort the received service data and the service data in the source transmission mode based on the SN difference, and submit the data in order.

In some implementations, the third indication information further includes the configuration information of the associated unicast bearer. For example, the configuration information may be information that is configured by the network side device and that carries an “on” instruction, that is, information instructing the terminal to establish the associated unicast bearer, or may be information that carries an “off” instruction, that is, instructing the terminal not to establish the associated unicast bearer. In some implementations, the protocol may stipulate that the terminal establishes the associated unicast bearer.

It should be noted that for a specific implementation process in which the network side device instructs the terminal to establish the associated unicast bearer and the terminal establishes the associated unicast bearer, refer to the specific descriptions in the foregoing embodiment in FIG. 2. Details are not described in this embodiment.

Further, after the network side device sends the third indication information, the method may further include at least one of the following:

receiving reception state information of multicast service data of the terminal; and

sending first target data to the terminal, where the first target data is multicast service data that fails to be received by the terminal.

The reception state information is used to indicate that data that is successfully received and data that fails to be received by the terminal. The network side device may retransmit the data that fails to be received to the terminal based on the reception state information, to ensure that the terminal continuously receives service data, thereby avoiding a data loss.

In some implementations, the network side device may send the first target data to the terminal without receiving the reception state information fed back by the terminal, where the first target data may be service data that fails to be received by the terminal, or the first target data may further include data that is successfully received by the terminal. For example, the network side device may send the last several data packets in the source transmission mode to the terminal. For example, when a data packet of L2 SN=258 is sent in the source transmission mode, transmission mode switching is performed. To ensure that the last several data packets can also be received, data packets of L2 SN=256, 257, and 258 may be retransmitted, to ensure that the terminal continuously receive service data, thereby avoiding a data loss.

In this embodiment of this application, in a case that the source transmission mode is a PTM transmission mode, the method further includes at least one of the following:

receiving a mapping relationship between an L2 SN of service data sent by a source node in the source transmission mode and an SN of core network data, and determining an L2 SN of service data in the target transmission mode based on the mapping relationship, where the L2 SN of the service data in the target transmission mode is the same as the L2 SN of the service data in the source transmission mode; and

determining a service period or a service change period of a cell, where in a same service period or service change period, service data sent by a cell corresponding to the source transmission mode is the same as service data sent by a cell corresponding to the target transmission mode, and/or a same data packet of the cell corresponding to the source transmission mode and the cell corresponding to the target transmission mode carries a same L2 SN.

The mapping relationship between the L2 SN of the service data and the SN of the core network data is determined by using at least one of the following:

negotiation of an interface between network nodes;

stipulation in a protocol; and

a centralized control network node, where the centralized control network node is used to distribute data to another network node that accesses the centralized control network node.

That is, the mapping relationship between the L2 SN of the service data in the source transmission mode and the SN of the core network data may be determined through interface negotiation between network nodes of two cells, or may be directly stipulated in the protocol, or may be determined by the centralized control network node.

In this embodiment of this application, when both the source transmission mode and the target transmission mode are a PTM transmission mode, the source cell and the target cell both use the PTM transmission mode to send service data. If sending by the source cell and sending by the target cell are not synchronized, reception duplicate or a reception gap may be caused (for example, the source cell receives SN=10, but the target cell sends SN=8 only, resulting in duplication, and vice versa, there is a gap), thereby affecting user experience. Therefore, the simplest way to improve user service continuity and reduce a data reception loss is to maintain relative synchronous service sending in a neighboring cell/a cell in which switching is frequent. In this embodiment of this application, the network side device may maintain relative synchronous service sending in the following manner: receiving a mapping relationship between an L2 SN of service data sent by a source node in the source transmission mode and an SN of core network data, and/or determining a service period or a service change period of a cell. Synchronous service sending is described below by using an example.

For example, a multicast service is mostly a periodic service, and there is a specified pattern, for example, a period length Discontinuous Reception (DRX) cycle and burst duration, for example, corresponding to On duration and/or a length of an inactivity timer, or even interaction may be considered for an offset starting at the beginning of the period. In this case, the network side device may transmit the information on an interface in two neighboring cells, to ensure that configurations of the neighboring cells are basically consistent or coordinated.

In addition, SN identifiers of service data are synchronized. The network side device may transmit service SN information on the interface (that is, a mapping relationship between an SN of an XG interface and an SN of an air interface). For example, a multicast channel from a core network to a base station is totally the same for each cell, that is, when data of the core network is sent to each base station, an SN identifier of an interface used by a same service data packet is the same. For example, for a GTP-U SN of a GTP-U tunnel of an Xn interface, content of a data packet of GTP-U SN=100 sent to a cell 1 is exactly the same as that of a data packet of GTP-U SN=100 sent to a cell 2. In this way, if the cell 1 allocates PDCP SN=0 (the PDCP SN is used as an example, and other L2 SNs are not excluded) to the data packet of GTP-U SN=100 for air interface multicast sending, the cell 1 sends mapping information of the SN to the cell 2 by using the Xn interface, and the cell 2 allocates the same PDCP SN=0 to the same data packet of GTP-U SN=100 during air interface multicast sending. In this way, data packet labels of neighboring cells are the same, thereby greatly improving reception continuity and a lossless probability of the UE. For example, the UE receives data PDCP SN=100 corresponding to a TMGI in the source cell 1. When switching or moving to the cell 2, the UE continues to receive data of the TMGI, PDCP SN=99, 100, 101, 102 . . . , and the UE may learn that 99 and 100 are duplicate data and may be deleted.

In some implementations, based on the foregoing second implementation, strict synchronization is specified (that is, it is required that a same L2 SN of an air interface is allocated to a same data packet by a neighboring cell). For example, a cell 1 first joins a multicast group, and allocates PDCP SN=0 to a data packet of GTP-U SN=100. Then a cell 2 joins the multicast group, and allocates PDCP SN=0 to a data packet of GTP-U SN=500. In this case, L2 SNs allocated to a same data packet by the two cells are deviated, and this deviation may be notified to the UE for reordering. In some implementations, the premise is that an interface between the two cells notifies each other of an L2 SN allocation manner and calculates the deviation. For example, the interface receives information about a neighboring cell. If the neighboring cell allocates PDCP SN=400 to a data packet whose service allocation manner of a specific TMGI is GTP-U SN=500, and the current cell allocates PDCP SN=0 to the data packet of GIP-U SN=500, the UE may be notified by using dedicated signaling or an SIB that a deviation of L2 SNs between the current cell and a neighboring cell 1 is +400 (it is assumed that a difference is defined as SN of the neighboring cell−SN of the current cell), or may be notified that a deviation is −400 (it is assumed that a difference is defined as SN of the current cell−SN of the neighboring cell). After obtaining information about the difference, the UE may continuously receive and reorder data. For example, after the UE receives a data packet of L2 SN=8 in the current cell, and learns that the SN difference is 400 after being switched to or re-selected to the neighboring cell 1. In this case, the received L2 SN of the new cell 1=407, 408, 409, . . . , so that it can be learned that the first two are duplicated packets, and may be deleted and submitted after reordering.

In some implementations, a specific period may be set for different cells, for example, a service period or a service change period, to ensure that data packets sent by different cells in this period are the same, regardless of a scheduling manner and a specific L2 number. For example, if a period of a TMGI service is 20 ms, data sent by a neighboring cell in each 20 ms must be synchronized, where 20 ms may be aligned, or may be deviated. For example, a start moment of sending in a period of a first cell is 0, 20 ms, 40 ms . . . , and a start moment of sending in a period of a second cell is 1 ms, 21 ms, 41 ms and the like. In this way, the UE receives data in the first period of 20 ms (0-19 ms) in the first cell, moves to the second cell, and starts to receive data in the second period (21-40 ms). The data in the two periods may be sorted consecutively in order in a lossless manner. To achieve this effect, a synchronization period also needs to be set for an interface between cells.

In addition, a service change period is used as an example. When a service period is 20 ms, and a service change period is set to 80 ms, a service may be extended or retransmitted specifically within 20 ms. However, it needs to be ensured that content transmitted by different cells in 80 ms is the same. The UE moves from one cell to another cell, and 80 ms may be used as a boundary for continuous and lossless reception.

In this embodiment of this application, in a case that the target transmission mode is a PTP transmission mode, the method further includes at least one of the following:

receiving SN state information of received service data that is reported by the terminal, where the SN state information includes at least one of service data that is successfully received and service data that fails to be received; and

sending second target data to the terminal, where the second target data is unicast service data that fails to be received by the terminal.

For example, the network side device may learn, based on the SN state information reported by the terminal, which data fails to be received by the terminal. The network side device can retransmit the data that fails to be received to the terminal, to ensure that the terminal continuously receives service data, thereby avoiding a data loss.

In some implementations, the network side device may send the second target data to the terminal without receiving the SN state information fed back by the terminal, where the second target data may include unicast service data that fails to be received by the terminal, or the first target data may include data that is successfully be received by the terminal, or may include data that fails to be received by the terminal. For example, when a data packet of L2 SN=258 is sent in the source transmission mode, transmission mode switching is performed. To ensure that the last several data packets can also be received, data packets of L2 SN=256, 257, and 258 may be retransmitted, to ensure that the terminal continuously receive service data, thereby avoiding a data loss.

In this embodiment of this application, before the receiving configuration information of a target transmission mode of a multicast service, the method further includes:

receiving second assistance information sent by the network side device based on the CP, where the second assistance information is used to indicate that the target transmission mode is a PTP transmission mode.

To better understand this solution, the following separately describes a procedure of the CP and a procedure of the UP with reference to transmission of service data in the PTP transmission mode.

In some implementations, when switching to the PIT transmission mode, the terminal may receive the multicast service data based on the initialized unicast bearer, and the network side device may include the following procedure based on the CP:

Because the target transmission mode is a PTP transmission mode, the second assistance information may be notified, by using dedicated Radio Resource Control (RRC) signaling, that the UE switches to the PTP transmission mode.

A correspondence between service data in the source transmission mode and service data in the target transmission mode may be carried in the dedicated RRC signaling, for example, L2 SN=256 in the source transmission mode is consistent with L2 SN=0 in the target transmission mode.

Further, to ensure lossless data reception, a specific overlapping area may be reserved for the service data transmitted in the source transmission mode and the service data transmitted in the target transmission mode, so that the performs continuous reception. For example, when the service data in the source transmission mode is transmitted to a data packet of L2 SN=258, the transmission mode is switched. To ensure that the last several data packets can also be received, data packets of L2 SN=256, 257, and 258 may be retransmitted in the PTP transmission mode. In the PTP transmission mode, the terminal may initialize an SN of a received data packet, that is, L2 SNs of the received data packets of L2 SN=256, 257, and 258 may be numbered from 0 again, and new L2 SNs are 0, 1, 2.

In addition, when mode switching occurs in a same cell, a specific time may also be reserved for both unicast and multicast, to ensure continuity of service data. For example, if L2 SN-256 is sent in the PTM transmission mode, the network side device sends dedicated reconfiguration signaling, and switches to the PTP transmission mode to send service data. If a data packet of L2 SN=0 in the target transmission mode (a data packet corresponding to L2 SN=256 in the PTM transmission mode) is sent, L2 SN=0, 1, 2, 3 . . . are sent in the PTP transmission mode, and L2 SN=257 (corresponding to L2 SN=1 in the PTP transmission mode), 258 (corresponding to L2 SN=2 in the PTP transmission mode), 259 (corresponding to L2 SN=3 in the PTP transmission mode), 260 (corresponding to L2 SN=4 in the PTP transmission mode) . . . may continue to be sent in the VIM transmission mode. The UE may receive data simultaneously, and perform duplicate detection and reordering.

In some implementations, when switching to the PTP transmission mode, the terminal may receive the multicast service data based on the initialized unicast bearer, and the network side device may include the following procedure based on the UP:

Because the target transmission mode is a PTP transmission mode, the second assistance information may be notified, by using dedicated RRC signaling, that the UE switches to the PTP transmission mode.

Specific indication information such as a special mark may be carried in the dedicated RRC signaling, indicating that a target TMGI service needs to support continuous reception or, in other words, support lossless transmission of the target TMGI service. The UE establishes a new unicast PTP bearer according to the indication information in the dedicated RRC signaling.

The network side establishes a correspondence between a source transmission mode bearer and the new PTP bearer in a UP PDU or a UP control PDU, such as a PDCP PDU or a PDCP control PDU, of the PTP bearer. For example, on the basis of carrying an SN of the new PTP bearer, an SN value of a data packet corresponding to the source transmission mode is increased, to indicate a peer relationship. For example, a data packet of L2 SN=256 in the source transmission mode is consistent with a data packet of L2 SN=0 in the PTP transmission mode.

Further, to ensure lossless data reception, a specific overlapping area may be reserved for the service data transmitted in the source transmission mode and the service data transmitted in the target transmission mode, so that the UE performs continuous reception. For example, when the service data in the source transmission mode is transmitted to a data packet of L2 SN=258, the transmission mode is switched. To ensure that the last several data packets can also be received, data packets of L2 SN=256, 257, and 258 may be retransmitted in the PTP transmission mode. In the PTP transmission mode, the terminal may initialize an SN of a received data packet, that is, L2 SNs of the received data packets of L2 SN=256, 257, and 258 may be numbered from 0 again, and new L2 SNs are 0, 1, 2.

In addition, when mode switching occurs in a same cell, a specific time may also be reserved for both unicast and multicast, to ensure continuity of service data. For example, if L2 SN=256 is sent in the PTM transmission mode, the network side device sends dedicated reconfiguration signaling, and switches to the PTP transmission mode to send service data. If a data packet of L2 SN=0 in the target transmission mode (a data packet corresponding to L2 SN=256 in the PTM transmission mode) is sent, L2 SN=0, 1, 2, 3 . . . are sent in the PTP transmission mode, and L2 SN=257 (corresponding to L2 SN=1 in the PTP transmission mode), 258 (corresponding to L2 SN=2 in the PTP transmission mode), 259 (corresponding to L2 SN=3 in the PTP transmission mode), 260 (corresponding to L2 SN=4 in the PTP transmission mode) . . . may continue to be sent in the PTM transmission mode. The UE may receive data simultaneously, and perform duplicate detection and reordering.

In some implementations, when switching to the PTP transmission mode, an SN state of service data in the PTP transmission mode may be maintained based on an SN state of service data in the source transmission mode. In this case, the network side device may include the following procedure based on the CP:

Because the target transmission mode is a PTP transmission mode, the second assistance information may be notified, by using dedicated RRC signaling, that the UE switches to the PTP transmission mode.

State information of the service data in the source transmission mode may be carried in the dedicated RRC signaling, for example, a data packet of L2 SN=258 sent in the source transmission mode.

The UE receives the dedicated RRC signaling, and sets an initial variable value of a PTP bearer L2 entity in the target transmission mode according to the state information of the service data in the source transmission mode, for example, an initial value of an L2 SN is 258.

Further, to ensure lossless data reception, a specific overlapping area may be reserved for the service data transmitted in the source transmission mode and the service data transmitted in the target transmission mode, so that the UE performs continuous reception. For example, when the service data in the source transmission mode is transmitted to a data packet of L2 SN=258, the transmission mode is switched. To ensure that the last several data packets can also be received, data packets of L2 SN=256, 257, and 258 may be retransmitted in the PTP transmission mode. If the UE fail to receive data packets of 256 and 257 earlier, compensation for a reception gap may be performed. If the UE successfully receives the data packets of 256 and 257 earlier, the data packets are directly deleted as duplicated data. In this way, it can be ensured that the terminal can continuously receive service data, thereby avoiding a data loss.

In addition, when mode switching occurs in a same cell, a specific time may also be reserved for both unicast and multicast, to ensure continuity of service data. For example, if L2 SN=256 is sent in the PTM transmission mode, the network side device sends dedicated reconfiguration signaling, and switches to the PTP transmission mode to send service data. An L2 SN in the target transmission mode may maintain the same as an L2 SN in the source transmission mode. For example, data packets of L2 SN=256, 257, and 258 are sent in the source transmission mode, and the data packets of L2 SN=256, 257, and 258 are also sent in the PTP transmission mode. The UE may receive data simultaneously, and perform duplicate detection and reordering. In this way, a data loss is further avoided, thereby ensuring that the terminal can continuously receive data.

In some implementations, when switching to the PTP transmission mode, an SN state of service data in the PTP transmission mode may be maintained based on an SN state of service data in the source transmission mode. In this case, the network side device may include the following procedure based on the UP:

Because the target transmission mode is a PTP transmission mode, the second assistance information may be notified, by using dedicated RRC signaling, that the UE switches to the PTP transmission mode.

Specific indication information may be carried in the dedicated RRC signaling, for example, a mark for performing a lossless operation, indicating that a target TMGI service needs to support lossless transmission. The UE establishes a new PTP bearer according to the dedicated RRC signaling, and performs special processing according to the mark of the lossless operation. The special processing may be continuing a state of the service data in the source transmission mode and a state of the service data in the PTP transmission mode. For example, a data packet of L2 SN=256 is received in the source transmission mode, and a data packet of L2 SN=257 is received in the PTP transmission mode. It may be considered that the two are consecutive and are submitted in order.

Further, to ensure lossless data reception, a specific overlapping area may be reserved for the service data transmitted in the source transmission mode and the service data transmitted in the PTP transmission mode, so that the UE performs continuous reception. For example, when the service data in the source transmission mode is transmitted to a data packet of L2 SN=258, the transmission mode is switched. To ensure that the last several data packets can also be received, data packets of L2 SN=256, 257, and 258 may be retransmitted in the PTP transmission mode. If the UE fail to receive data packets of 256 and 257 earlier, compensation for a reception gap may be performed. If the UE successfully receives the data packets of 256 and 257 earlier, the data packets are directly deleted as duplicated data. In this way, it can be ensured that the terminal can continuously receive service data, thereby avoiding a data loss.

In addition, when mode switching occurs in a same cell, a specific time may also be reserved for both unicast and multicast, to ensure continuity of service data. For example, if L2 SN=256 is sent in the PTM transmission mode, the network side device sends dedicated. reconfiguration signaling, and switches to the PTP transmission mode to send service data. An L2 SN in the target transmission mode may maintain the same as an L2. SN in the source transmission mode. For example, data packets of L2 SN=256, 257, and 258 are sent in the source transmission mode, and data packets of L2 SN=257, 258, and 259 are sent in the PTP transmission mode. SNs of service data in the source transmission mode may be directly sorted. The UE may receive data simultaneously, and perform duplicate detection and reordering. In this way, a data loss is further avoided, thereby ensuring that the terminal can continuously receive data.

In this embodiment of this application, switching between the target transmission mode and the source transmission mode may be performed between network nodes. In some implementations, in a case that a target node corresponding to the target transmission mode is different from a source node corresponding to a source transmission mode, the method further includes at least one of the following:

sending SN state transfer indication information to the source node, where the SN state transfer indication information is used to instruct the source node to perform SN state transfer on service data;

sending a data forwarding request to the source node, where the data forwarding request is used to instruct the source node to perform data forwarding;

receiving service data on which the source node performs data forwarding;

for service data corresponding to a temporary mobile group identifier TMGI, receiving an upper limit of an SN value of service data that has been sent by the source node, where the SN is at least one of an L2 SN and an SN of a core network;

receiving SN information of service data that fails to be sent by the source node, where the SN is at least one of an L2 SN and an SN of a core network; and

receiving a correspondence between an L2 SN of service data of the source node and an SN of a core network.

It should be noted that in this embodiment of this application, the target node is used as the network side device to perform the foregoing solution.

For example, the target node may send SN state transfer indication information to the source node, to instruct the source node to perform SN state transfer on service data. In some implementations, before the target node sends the SN state transfer indication information, the source node may send SN state transfer recommendation information to the target node, to recommend that the target node determines whether an SN state needs to be maintained for the terminal. If yes, the target node sends the SN state transfer indication information to the source node.

In some implementations, the target node may send a data forwarding request to the source node, to instruct the source node to perform data forwarding. In some implementations, the source node may actively perform data forwarding without receiving the data forwarding request sent by the target node, and may send service data on which data forwarding is performed to the target node.

It should be noted that, in a case that the source node performs data forwarding, the service data on which the source node performs data forwarding further includes at least one of an L2 SN carried in each forwarding packet and an SN of a core network. For example, if the forwarding data packet carries a PDCP SN, it means that an SN state of service data of the UE is maintained, and the target node sends service data corresponding to the forwarding data packet to the UE by using the carried PDCP SN, so that the UE performs detection and reordering on service data.

In some implementations, an SN state transfer indication may be an indication based on a specific TMGI. For service data corresponding to the TMGI, an upper limit of an SN value of one piece of service data that has been sent by the source node is received, and the target node may preform continuous sending and state maintaining on service data based on the upper limit of the SN value of the service data. For example, if the source node has sent a data packet of L2 SN=256, and the source node sends an upper limit 256 of an L2 SN of service data to the target node, the target node may continue to send a data packet of L2 SN=257.

In some implementations, the target node may receive SN information of service data that fails to be sent and that is of the source node, and the target node can continue to send the service data that fails to be sent. For example, when switching to the target node, the source node has sent a data packet of L2 SN=256, and the source node sends, to the target node, SN information of service data of L2 SN=255 and 256 that fail to be sent. In this case, the target node may send the data packet of L2 SN=255 and 256 again.

In some implementations, the target node may receive the correspondence between the L2 SN of the service data of the source node and the SN of the core network, so that the target node can perform state continuity on received service data based on the correspondence between the L2 SN of the service data of the source node and the SN of the core network.

In some implementations, the upper limit of the SN value is determined by using any one of the following:

an SN value of a last data packet sent by the source node on the TMGI before sending a mode switching request command to the terminal;

an SN value of a last data packet sent by the source node on the TMGI;

an SN value of a last data packet sent by the source node on the TMGI before sending a mode switching request command to the terminal and receiving an ACKnowledgement (ACK);

an SN value of a last data packet sent by the source node on the TMGI before performing SN state transfer; and

an SN value of any data packet sent by the source node on the TMGI.

In some implementations, in a case that the SN state transfer includes the upper limit of the SN value and the target transmission mode is a PTP transmission mode, the method further includes any one of the following:

sending first target data to the terminal, where the first target data is service data that fails to be received by the terminal;

sending service data to the terminal based on an SN value of a last data packet sent by the source node, where a Core Network (CN) SN value of a first data packet of the service data is consecutive to a CN SN value of the last data packet sent by the source node;

sending service data to the terminal based on the L2 SN, where an L2 SN of the service data is consecutive to the L2 SN of the service data sent by the source node; and

sending service data to the terminal based on the L2 SN, where an L2 SN of the service data is an initialized SN.

It should be noted that an L2 SN may be an PDCP SN, or an SN of another L2 protocol layer, such as Radio Link Control (RLC), a Backhaul Adaptation Protocol (BAP), or a Service Data Adaptation Protocol (SDAP). The SN of the Core Network (CN) may be an SN that if of a data pipeline from the CN to a Radio Access Network (RAN) and that is for the TMGI, for example, a GTP-U SN.

To better understand the foregoing solution, the following describes the foregoing solution by using specific embodiments.

Step 1: When the source node sends a switching request message to the target node, reception information about an MBS service that the UE is interested, such as TMGI information, or even specific Quality of Service (QoS) information is carried, and a sending state of a corresponding service of interest to the UE may also be included, for example, a PTP/PTM transmission mode, sending information (for example, an SN of a XG interface is based on a specific period or a specific moment), or the sending state of the service of interest may be notified. through a change between interfaces, without notification of per UE. In this way, the target node can make a configuration decision based on content carried in the switching request message.

Step 2: When receiving the switching request information of the source node, the target node accepts the UE, and not only needs to accept a unicast service, but also needs to accept an MBS service, for example, a to-be-used transmission mode (PTP/PTM), a bearer configuration, and an initial state of an optional L2 entity.

When determining to use the PTP transmission mode to carry an MBS service of interest to the UE, the target node may further determine, according to a block error rate/delay/lossless requirement of a service, whether to perform state maintenance for the UE. If yes, the switching command carries the SN state transfer indication, and a switching request response message returned to the source node requires the source node to perform SN state transfer.

In addition, when the target node is in an MBS service sending state with the source node (for example, there is missing data in the middle, or the target node newly joins a multicast group, and there is little data before), and data forwarding of a multicast service finally needs to be performed according to a requirement of a service block error rate/latency/lossless, a forwarding channel is established for the TMGI, and forwarding channel information is returned to the source base station.

Step 3: The source node receives the switching request response message of the target node, and sends the switching command to the UE. That the source node performs SN state transfer according to the SN state transfer indication of the target node may include the following manners:

Manner 1

For service data corresponding to a TMGI, an upper limit of an SN value of a service that has been sent by the source node is received, for example, a GTP-U SN of a uniform identifier in a core network multicast channel. The GTP-U SN is uniformly numbered by the source node and the target node, and a same SN certainly corresponds to a same data packet. The upper limit of the SN value may be determined by using any one of the following:

an SN value of a last data packet sent by the source node on the TMGI before sending a switching command to the UE;

an SN value of a last data packet sent by the source node to the UE on the TMGI;

an SN value of a last data packet sent by the source node on the TMGI before sending a switching command to the UE and receiving an ACK, where the ACK is a Hybrid Automatic Repeat reQuest ACKnowledgement (HARQ ACK) or a Radio Link Control ACKnowledgement (RLC ACK);

an SN value of a last data packet sent by the source node on the TMGI before performing SN state transfer; and

an SN value of any data packet sent by the source node on the TMGI depending on the implementation.

Manner 2

For service data corresponding to a TMGI, not only a CN SN of a service that has been sent by the source node is required, but also an L2 SN corresponding to the data is required for air interface transmission. For service data corresponding to a TMGI, an upper limit of an SN value of a multicast channel of a service that has been sent by the source node is sent, for example, a GTP-U SN value of an XG interface. In addition, an L2 SN of the data packet transmitted at an air interface is sent, for example, a PDCP SN. A meaning is a data content identifier and an air interface sending SN identifier of last multicast service data sent by the source node, so that the target node performs continuous sending and state continuity. A manner of determining the SN upper limit is similar to the foregoing manner, and details are not described again.

Manner 3

In addition to sending a GTP-U SN and a Uu L2 SN of the last data packet in the manner 2, data that fails to be received before the last data packet may be listed according to a feedback (a HARQ feedback or an RLC feedback) of the UE. For example, if the last sent PDCP SN is 100, data that carries 98 and 96 fails to be received.

In addition, the source node may further establish a forwarding channel according to the data forwarding request of the target node and data forwarding channel information, and transmit corresponding data to the target base station on the forwarding channel. This includes at least one of the following:

The forwarding channel needs to be identified by a per TMGI, and each TMGI occupies one forwarding channel independently, for example, has an independent Tunnel Endpoint IDentifier (TEID), or a plurality pf TMGI services may multiplex one forwarding channel, but different TMGI services are distinguished in data packets, for example, display a carried TMGI field.

Each forwarding data packet may carry a GTP-U SN value on an XG interface of an original multicast core network channel, so that the target node can recognize a data sequence. Corresponding to the manner 1, forwarding starts to be performed on data after the last SN sent by the source node.

Each forwarding data packet may also carry an L2 SN, such as a PDCP SN, allocated during sending on a Uu air interface, so that the target side can continue to use a PDCP state. Corresponding to the manner 2, forwarding starts to be performed on data that carries a GTP-U SN and a PDCP SN after the last SN sent by the source node.

Data forwarding needs to be performed on data packets from old to new, for example, in an ascending order of GTP-U SNs.

Corresponding to the foregoing manner 3, forwarding is performed on data that fails to be received and data that carries a GTP-U SN and a PDCP SN after the last SN sent by the source node. Data forwarding may not be totally consecutive, and corresponds to the manner 3 of SN state forwarding. When the last sent PDCP SN is 100, and 98 and 96 fail to be received, forwarding content is sequentially 96, 98, 101, 102, and 103.

Step 4: The target node receives SN state information and/or data forwarding information of the source node, and performs the following processing:

In the manner 1, the target side also has same multicast data. To support the UE that is switched from the source cell in which sending is slow, each cell may buffer some multicast data, to meet continuous transmission for the UE. In the manner 1, the source node transmits, to the target node, an upper limit of a GTP-U SN sent by the source node. At the target node, multicast data is continuously provided for the UE from the SN, thereby ensuring continuity.

For the PTM transmission mode, the foregoing operation may also be performed. For example, if the source node sends a data packet of SN=100, and the target node has sent a data packet of SN=102, the data packet of SN=102 may be retransmitted by using PTM for switching of the UE.

For the PTP transmission mode, because a UE dedicated bearer is used, transmission may be started from a required SN location to ensure service continuity.

In the manner 2, the L2 SN is carried in addition to the GTP-U SN. For the PTP transmission mode, a UE dedicated bearer is used, so that continuous transmission of multicast data can be provided for the UE according to consecutive L2 SNs. The UE only needs to maintain an original L2 SN context state, and perform gap filling and duplicate detection, thereby implementing continuous and lossless transmission.

In the manner 3, an unsuccessful SN identifier is further carried in addition to the GTP-U SN and the corresponding L2 SN. For the PTM transmission mode, for one UE, costs of changing the L2 SN of the entire PTM are relatively high, which affects another UE. However, selective retransmission may be performed on the premise that the PTM SN is maintained, so that the UE can perform gap filling and duplicate detection by using SN mapping information of the source transmission mode and the target transmission mode.

In a PTP manner, a UE dedicated bearer is used, so that continuous transmission of multicast data can be provided for the UE according to consecutive L2 SNs, and only data packets that fail to be received and that are fed back by the UE are accurately retransmitted, thereby improving retransmission efficiency. The UE only needs to maintain an original L2 SN context state, and perform gap filling and duplicate detection, thereby implementing continuous and lossless transmission.

When receiving forwarding data, the target node identifies the data according to a GTP-SN of the forwarding data, and arranges sequential transmission for the UE. If a PDCP SN is further carried, it means that a state of the UE is maintained. A corresponding data packet needs to be sent to the UE by using the carried PDCP SN, to perform detection and reordering.

According to the technical solution provided in this embodiment of this application, a network side device sends configuration information of a target transmission mode of a multicast service to a terminal, so that the terminal can determine the target transmission mode based on the configuration information, and continuously receive multi cast service data based on the target transmission mode, to ensure continuity of service data received by the terminal in the target transmission mode, and avoid impaired data quality caused by discontinuity of service data reception. In this way, the network side device can perform MBS service transmission in a more efficient manner, thereby improving data transmission efficiency of a communications system.

It should be noted that the data transmission method provided in the embodiments of this application may be performed by a data transmission apparatus, or a control module that is in the data transmission apparatus and that is configured to perform the data transmission method. In the embodiments of this application, that the data transmission apparatus performs the data transmission method is used as an example to describe the data transmission apparatus provided in the embodiments of this application.

Referring to FIG. 4, FIG. 4 is a structural diagram of a data transmission apparatus according to an embodiment of this application. The data transmission apparatus is applied to a terminal. As shown in FIG. 4, a data transmission apparatus 400 includes:

a first receiving module 401, configured to receive configuration information of a target transmission mode of a multicast service; and

a second receiving module 402, configured to continuously receive service data based on the configuration information of the target transmission mode.

In some implementations, in a case that the target transmission mode is a PTM transmission mode, the second receiving module 402 is further configured to perform at least one of the following:

receiving first assistance information sent by a network side device based on a CP or a UP, and receiving and reordering the service data based on the first assistance information, where the first assistance information is used to indicate a correspondence between an SN of a source transmission mode and an SN of the target transmission mode;

obtaining explicit or implicit first indication information, and establishing a multicast bearer from an SN initialization state based on the first indication information to continuously receive the service data;

obtaining explicit or implicit second indication information, and establishing a multicast bearer from an SN hold state based on the second indication information to continuously receive the service data; and

establishing an associated unicast bearer, and continuously receiving the service data based on the associated unicast bearer.

In some implementations, in a case that the first assistance information is sent based on the UP, the first assistance information is carried in a L2 control PDU or an L2 PDU header.

In some implementations, in a case that the source transmission mode is a PIM transmission mode, the second receiving module 402 is further configured to:

establish a multicast bearer based on the target transmission mode, maintain an SN state of the target transmission mode the same as an SN state of the source transmission mode, and continuously receive the service data.

In some implementations, the second receiving module 402 is further configured to:

in a case that the source transmission mode is switched to the target transmission mode, establish the associated unicast bearer based on third indication information, where the third indication information is used to indicate a target service for which the associated unicast bearer needs to be established.

In some implementations, in a case that the associated unicast bearer is established, the second receiving module 402 is further configured to perform at least one of the following:

sending service reception state information to the network side device by using the associated unicast bearer;

receiving first target data sent by the network side device, and reordering the first target data and received data; and

receiving a target SN correspondence sent by the network side device, and receiving and reordering the service data based on the target SN correspondence, where the target SN correspondence is a correspondence between the SN of the source transmission mode and the SN of the target transmission mode.

In some implementations, in a case that the target transmission mode is a PTP transmission mode, the second receiving module 402 is further configured to:

establish a unicast bearer, and receive multicast service data based on the unicast bearer, where an SN state of service data received in the target transmission mode is maintained based on an SN state of service data received in a source transmission mode; or

establish an initialized unicast bearer, and receive multicast service data based on the initialized unicast bearer, where an SN of service data received based on the target transmission mode is an initialized SN.

In some implementations, in a case that the target transmission mode is a PTP transmission mode, and an SN state of service data received in the target transmission mode is maintained based on an SN state of service data received in a source transmission mode, the apparatus further includes:

a reporting module, configured to report SN state information of received service data, where

the SN state information includes at least one of service data that is successfully received and service data that fails to be received.

In this embodiment of this application, a data transmission apparatus can determine a target transmission mode based on configuration information, and then continuously receive multicast service data based on the target, transmission mode, to ensure continuity of service data received by the data transmission apparatus in the target transmission mode, and avoid impaired data quality caused by discontinuity of service data reception. In this way, a network side device can perform MBS service transmission in a more efficient manner, thereby improving data transmission efficiency of a communications system.

The data transmission apparatus in this embodiment of this application may be an apparatus, or may be a component, an integrated circuit, or a chip in a terminal. The apparatus may be a mobile terminal, or a non-mobile terminal. For example, the mobile device may include but is not limited to the types of the foregoing listed terminal 11, and the non-mobile terminal may be a server, a Network Attached Storage (NAS), a personal computer, a television, an automated teller machine, or a self-service machine. This is not specifically limited in the embodiments of this application.

The data transmission apparatus in this embodiment of this application may be an apparatus with an operating system. The operating system may be an Android operating system, an iOS operating system, or another possible operating system. This is not specifically limited in the embodiments of this application.

The data transmission apparatus provided in this embodiment of this application can implement the processes implemented in the data transmission method embodiment in FIG. 2, and achieve a same technical effect. To avoid repetition, details are not described herein again.

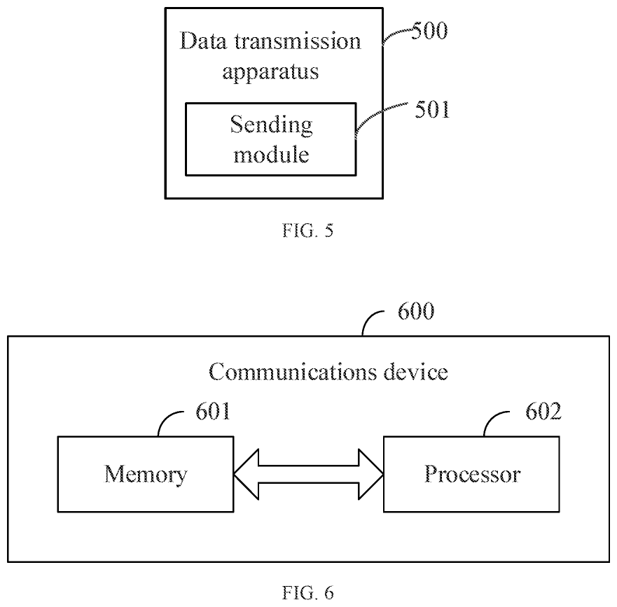

Referring to FIG. 5, FIG. 5 is a structural diagram of a data transmission apparatus according to an embodiment of this application. The data transmission apparatus is applied to a terminal. As shown in FIG. 5, a data transmission apparatus 500 includes:

a sending module 501, configured to send configuration information of a target transmission mode of a multicast service to a terminal, where

the configuration information is used to instruct the terminal to continuously receive service data based on the target transmission mode.

In some implementations, in a case that the target transmission mode is a PTM transmission mode, the sending module 501 is further configured to perform any one of the following:

sending first assistance information to the terminal based on a CP or a UP, where the first assistance information is used to indicate a correspondence between a SN of a source transmission mode and an SN of the target transmission mode;

sending explicit or implicit first indication information, where the first indication information is used to instruct the terminal to establish a multicast bearer from an SN initialization state to continuously receive the service data;

sending explicit or implicit second indication information, where the second indication information is used to instruct the terminal to establish a multicast bearer from an SN hold state to continuously receive the service data; and

sending third indication information, where the third indication information is used to instruct the terminal to establish an associated unicast bearer.

In some implementations, in a case that the first assistance information is sent based on the UP, the first assistance information is carried in a L2 control PDU or an L2 PDU header.

In some implementations, the third indication information includes at least one of the following:

a target service for which the associated unicast bearer needs to be established;

an SN difference between an SN of service data in the source transmission mode and an SN of service data in the target transmission mode; and

configuration information of the associated unicast bearer.

In some implementations, the apparatus further includes:

a first receiving module, configured to receive reception state information of multicast service data of the terminal; and/or

the sending module 501 is further configured to send first target data to the terminal, where the first target data is multicast service data that fails to be received by the terminal.

In some implementations, in a case that the source transmission mode is a PTM transmission mode, the apparatus further includes a determining module, configured to perform at least one of the following:

receiving a mapping relationship between an L2 SN of service data sent by a source node in the source transmission mode and an SN of core network data, and determining an L2 SN of service data in the target transmission mode based on the mapping relationship, where the 12 SN of the service data in the target transmission mode is the same as the L2 SN of the service data in the source transmission mode; and

determining a service period or a service change period of a cell, where in a same service period or service change period, service data sent by a cell corresponding to the source transmission mode is the same as service data sent by a cell corresponding to the target transmission mode, and/or a same data packet carries a same L2 SN.

In some implementations, the mapping relationship between the L2 SN of the service data and the SN of the core network data is determined by using at least one of the following:

negotiation of an interface between network nodes;

stipulation in a protocol; and

a centralized control network node, where the centralized control network node is used to distribute data to another network node that accesses the centralized control network node.

In some implementations, in a case that the target transmission mode is a point-to-point PTP transmission mode, the apparatus further includes:

a second receiving module, configured to receive SN state information of received service data that is reported by the terminal, where the SN state information includes at least one of service data that is successfully received and service data that fails to be received; and/or

the sending module 501 is further configured to send second target data to the terminal, where the second target data is unicast service data that fails to be received by the terminal.

In some implementations, in a case that a target node corresponding to the target transmission mode is different from a source node corresponding to a source transmission mode, the apparatus further includes a processing module, and the processing module is configured to perform at least one of the following:

sending SN state transfer indication information to the source node, where the SN state transfer indication information is used to instruct the source node to perform SN state transfer on service data;

sending a data forwarding request to the source node, where the data forwarding request is used to instruct the source node to perform data forwarding;

receiving service data on which the source node performs data forwarding;

for service data corresponding to a TMGI, receiving an upper limit of an SN value of service data that has been sent by the source node, where the SN is at least one of an L2 SN and an SN of a core network;

receiving SN information of service data that fails to be sent by the source node, where the SN is at least one of an L2 SN and an SN of a core network; and

receiving a correspondence between an L2 SN of service data of the source node and an SN of a core network.

In some implementations, the upper limit of the SN value is determined by using any one of the following:

an SN value of a last data packet sent by the source node on the TMGI before sending a mode switching request command to the terminal;

an SN value of a last data packet sent by the source node on the TMGI;

an SN value of a last data packet sent by the source node on the TMGI before sending a mode switching request command to the terminal and receiving an ACK;

an SN value of a last data packet sent by the source node on the TMGI before performing SN state transfer; and

an SN value of any data packet sent by the source node on the TMGI.

In some implementations, in a case that the SN state transfer includes the upper limit of the SN value and the target transmission mode is a PTP transmission mode, the sending module 501 is further configured to perform any one of the following:

sending first target data to the terminal, where the first target data is service data that fails to be received by the terminal;

sending service data to the terminal based on an SN value of a last data packet sent by the source node, where a CN SN value of a first data packet of the service data is consecutive to a CN SN value of the last data packet sent by the source node;

sending service data to the terminal based on the L2 SN. where an L2 SN of the service data is consecutive to the L2 SN of the service data sent by the source node; and

sending service data to the terminal based on the L2 SN, where an L2 SN of the service data is an initialized SN.

In some implementations, in a case that the source node performs data forwarding, the service data on which the source node performs data forwarding further includes at least one of an L2 SN carried in each forwarding packet and an SN of a core network.

In this embodiment of this application, a data transmission apparatus sends configuration information of a target transmission mode of a multicast service to a terminal, so that the terminal can determine the target transmission mode based on the configuration information, and continuously receive multicast service data based on the target transmission mode, to ensure continuity of service data received by the terminal in the target transmission mode, and avoid impaired data quality caused by discontinuity of service data reception. In this way, a network side device can perform MBS service transmission in a more efficient manner, thereby improving data transmission efficiency of a communications system.

The data transmission apparatus in this embodiment of this application may be an apparatus with an operating system.

The data transmission apparatus provided in this embodiment of this application can implement the processes implemented in the data transmission method embodiment in FIG. 3, and achieve a same technical effect. To avoid repetition, details are not described herein again.

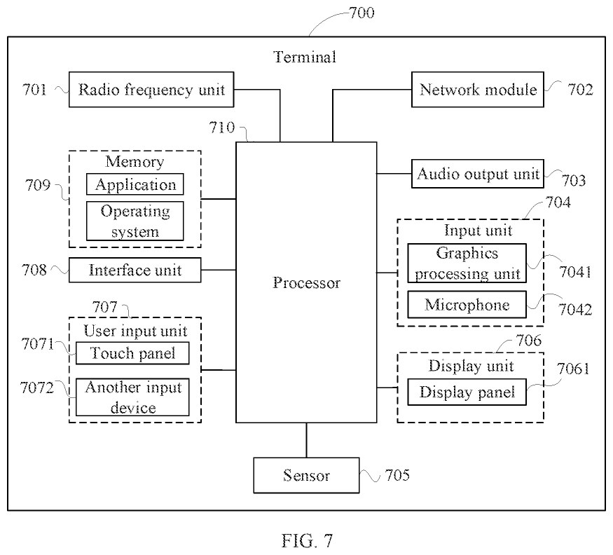

In some implementations, as shown in FIG. 6, an embodiment of this application further provides a communications device 600, including a processor 601, a memory 602, and a program or an instruction that is stored in the memory 602 and that can be run on the processor 601. For example, when the communications device 600 is a terminal, the program or the instruction is executed by the processor 601 to implement the processes of the data transmission method embodiment in FIG. 2, and a same technical effect can be achieved. When the communications device 600 is a network side device, the program or the instruction is executed by the processor 601 to implement the processes of the data transmission method embodiment in FIG. 3, and a same technical effect can be achieved. To avoid repetition, details are not described herein again.

FIG. 7 is a schematic structural diagram of hardware of a terminal according to an embodiment of this application.

A terminal 700 includes but is not limited to components such as a radio frequency unit 701, a network module 702, an audio output unit 703, an input unit 704, a sensor 705, a display unit 706, a user input unit 707, an interface unit 708, a memory 709, and a processor 710.

The terminal 700 may further include a power supply (such as a battery) that supplies power to each component. The power supply may be logically connected to the processor 710 by using a power supply management system, to implement functions such as charging and discharging management, and power consumption management by using the power supply management system. The terminal structure shown in FIG. 7 constitutes no limitation on the terminal, and the terminal may include more or fewer components than those shown in the figure, or combine some components, or have different component arrangements. Details are not described herein.

It should be understood that, in this embodiment of this application, the input unit 704 may include a Graphics Processing Unit (GPU) 7041 and a microphone 7042, and the graphics processing unit 7041 processes image data of a still picture or a video obtained by an image capture apparatus (such as a camera) in a video capture mode or an image capture mode. The display unit 706 may include a display panel 7061. In some implementations, the display panel 7061 may be configured in a form such as a liquid crystal display or an organic light-emitting diode. The user input unit 707 includes a touch panel 7071 and another input device 7072. The touch panel 7071 is also referred to as a touchscreen. The touch panel 7071 may include two parts: a touch detection apparatus and a touch controller. The another input device 7072 may include but is not limited to a physical keyboard, a functional button (such as a volume control button or a power on/off button), a trackball, a mouse, and a joystick. Details are not described herein.

In this embodiment of this application, the radio frequency unit 701 receives downlink data from a network side device and then sends the downlink data to the processor 710 for processing; and sends uplink data to the network side device. Usually, the radio frequency unit 701 includes but is not limited to an antenna, at least one amplifier, a transceiver, a coupler, a low noise amplifier, a duplexer, and the like.

The memory 709 may be configured to store a software program or an instruction and various data. The memory 709 may mainly include a program or instruction storage area and a data storage area. The program or instruction storage area may store an operating system, and an application or an instruction required by at least one function (for example, a sound playing function or an image playing function). In addition, the memory 709 may include a high-speed random access memory, and may further include a non-volatile memory. The non-volatile memory may be a Read-Only Memory (ROM), a Programmable ROM (PROM), an Erasable PROM (EPROM), an Electrically EPROM (EEPROM), or a flash memory, for example, at least one disk storage component, a flash memory component, or another non-volatile solid-state storage component.

The processor 710 may include one or more processing units. In some implementations, an application processor and a modern processor may be integrated into the processor 710. The application processor mainly processes an operating system, a user interface, an application, an instruction, or the like. The modem processor mainly processes wireless communications, for example, a baseband processor. It can be understood that, in some implementations, the modem processor may not be integrated into the processor 710.

The radio frequency unit 701 is configured to:

receive configuration information of a target transmission mode of a multicast service; and

continuously receive service data based on the configuration information of the target transmission mode.

In some implementations, in a case that the target transmission mode is a PIM transmission mode, the radio frequency unit 701 is further configured to implement at least one of the following:

receiving first assistance information sent by a network side device based on a CP or a UP, and receiving and reordering the service data based on the first assistance information, where the first assistance information is used to indicate a correspondence between an SN of a source transmission mode and an SN of the target transmission mode;

obtaining explicit or implicit first indication information, and establishing a multicast bearer from an SN initialization state based on the first indication information to continuously receive the service data;

obtaining explicit or implicit second indication information, and establishing a multicast bearer from an SN hold state based on the second indication information to continuously receive the service data; and
establishing an associated unicast bearer, and continuously receiving the service data based on the associated unicast bearer,

In some implementations, in a case that the first assistance information is sent based on the UP, the first assistance information is carried in a L2 control PDU or an L2 PDU header.

In some implementations, in a case that the source transmission mode is a PTM transmission mode, the radio frequency unit 701 is further configured to:

establish a multicast bearer based on the target transmission mode, maintain an SN state of the target transmission mode the same as an SN state of the source transmission mode, and continuously receive the service data.

In some implementations, the processor 710 is further configured to:

in a case that the source transmission mode is switched to the target transmission mode, establish the associated unicast bearer based on third indication information, where the third indication information is used to indicate a target service for which the associated unicast bearer needs to be established.

In some implementations, in a case that the associated unicast bearer is established, the radio frequency unit 701 is further configured to implement at least one of the following:

sending service reception state information to the network side device by using the associated unicast bearer;

receiving first target data sent by the network side device, and reordering the first target data and received data; and

receiving a target SN correspondence sent by the network side device, and receiving and reordering the service data based on the target SN correspondence, where the target SN correspondence is a correspondence between the SN of the source transmission mode and the SN of the target transmission mode.

In some implementations, in a case that the target transmission mode is a PTP transmission mode, the radio frequency unit 701 is further configured to:

establish a unicast bearer, and receive multicast service data based on the unicast bearer, where an SN state of service data received in the target transmission mode is maintained based on an SN state of service data received in a source transmission mode; or

establish an initialized unicast bearer, and receive multicast service data based on the initialized unicast bearer, where an SN of service data received based on the target transmission mode is an initialized SN.

In some implementations, in a case that the target transmission mode is a PTP transmission mode, and an SN state of service data received in the target transmission mode is maintained based on an SN state of service data received in a source transmission mode, the radio frequency unit 701 is further configured to:

report SN state information of received service data, where

the SN state information includes at least one of service data that is successfully received and service data that fails to be received.

In this embodiment of this application, a terminal can determine a target transmission mode based on configuration information, and then continuously receive multicast service data based on the target transmission mode, to ensure continuity of service data received by the terminal in the target transmission mode, and avoid impaired data quality caused by discontinuity of service data reception. In this way, a network side device can perform MBS service transmission in a more efficient manner, thereby improving data transmission efficiency of a communications system.

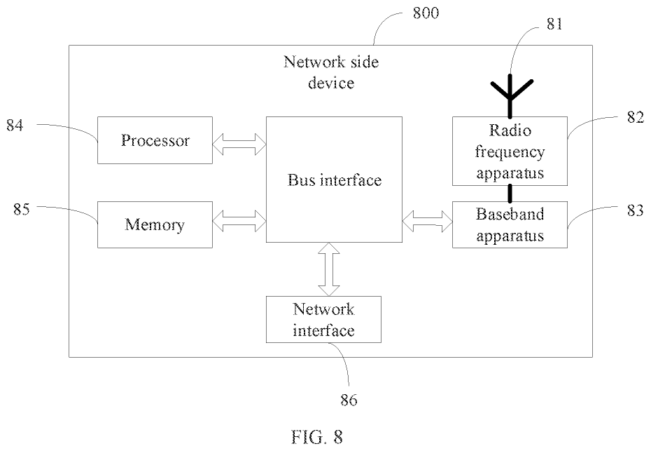

In some implementations, an embodiment of this application further provides a network side device. As shown in FIG. 8, a network device 800 includes an antenna 81, a radio frequency apparatus 82, and a baseband apparatus 83. The antenna 81 is connected to the radio frequency apparatus 82. In an uplink direction, the radio frequency apparatus 82 receives information by using the antenna 81, and sends the received information to the baseband apparatus 83 for processing. In a downlink direction, the baseband apparatus 83 processes information that needs to be sent, and sends processed information to the radio frequency apparatus 82. The radio frequency apparatus 82 processes the received information, and sends processed information by using the antenna 81.

The frequency band processing apparatus may be located in the baseband apparatus 83. The method performed by the network side device in the foregoing embodiment may be implemented in the baseband apparatus 83. The baseband apparatus 83 includes a processor 84 and a memory 85.

The baseband apparatus 83 may include, for example, at least one baseband board, where a plurality of chips are disposed on the baseband board. As shown in FIG. 8, one chip is, for example, the processor 84, which is connected to the memory 85, so as to invoke a program in the memory 85 to perform operations of the network device shown in the foregoing method embodiment.

The baseband apparatus 83 may further include a network interface 86, configured to exchange information with the radio frequency apparatus 82. For example, the interface is a Common Public Radio Interface (CPRI).

In some implementations, the network side device in this embodiment of the present invention further includes an instruction or a program that is stored in the memory 85 and that can be run on the processor 84. The processor 84 invokes the instruction or the program in the memory 85 to perform the method performed by the modules shown in FIG. 5, and a same technical effect is achieved. To avoid repetition, details are not described herein again.

An embodiment of this application further provides a readable storage medium. The readable storage medium stores a program or an instruction, and when the program or the instruction is executed by a processor, the processes of the data transmission method embodiment in FIG. 2 or the processes of the data transmission method embodiment in FIG. 3 are implemented and a same technical effect can be achieved. To avoid repetition, details are not described herein again.

The processor is a processor in the terminal in the foregoing embodiment. The readable storage medium includes a computer-readable storage medium, such as a computer Read-Only Memory (ROM), a Random Access Memory (RAM), a magnetic disk, or an optical disc.

An embodiment of this application further provides a chip. The chip includes a processor and a communications interface, the communications interface is coupled to the processor, and the processor is configured to run a program or an instruction of a network side device to implement the processes of the data transmission method embodiment in FIG. 2 or the processes of the data transmission method embodiment in FIG. 3 and a same technical effect can be achieved. To avoid repetition, details are not described herein again.

It should be understood that the chip mentioned in this embodiment of this application may also be referred to as a system-level chip, a system chip, a chip system, or an on-chip system chip.

It should be noted that, in this specification, the terms “include,” “comprise,” or their any other variant is intended to cover a non-exclusive inclusion, so that a process, a method, an article, or an apparatus that includes a list of elements not only includes those elements but also includes other elements which are not expressly listed, or further includes elements inherent to such process, method, article, or apparatus. An element limited by “includes a . . . ” does not, without more constraints, preclude the presence of additional identical elements in the process, method, article, or apparatus that includes the element. In addition, it should be noted that the scope of the method and the apparatus in the embodiments of this application is not limited to performing functions in an illustrated or discussed sequence, and may further include performing functions in a basically simultaneous manner or in a reverse sequence according to the functions concerned. For example, the described method may be performed in an order different from that described, and the steps may be added, omitted, or combined. In addition, features described with reference to some examples may be combined in other examples.

Based on the descriptions of the foregoing implementations, a person skilled in the art may clearly understand that the method in the foregoing embodiment may be implemented by software in addition to a necessary universal hardware platform or by hardware only. In most circumstances, the former is a preferred implementation. Based on such an understanding, the technical solutions of this application essentially or the part contributing to the prior art may be implemented in a form of a software product. The computer software product is stored in a storage medium (such as a ROM/RAM, a hard disk, or an optical disc), and includes several instructions for instructing a terminal (which may be mobile phone, a computer, a server, an air conditioner, a network device, or the like) to perform the methods described in the embodiments of this application.

The embodiments of this application are described above with reference to the accompanying drawings, but this application is not limited to the above specific implementations, and the above specific implementations are only illustrative and not restrictive. Under the enlightenment of this application, those of ordinary skill in the art can make many forms without departing from the purpose of this application and the protection scope of the claims, all of which fall within the protection of this application.

1. A data transmission method, performed by a terminal, wherein the method comprises:
receiving configuration information of a target transmission mode of a multicast service; and
continuously receiving service data based on the configuration information of the target transmission mode.

2. The method according to claim 1, wherein in a case that, the target transmission mode is a Point-To-Multipoint (PTM) transmission mode, the continuously receiving service data comprises at least one of the following:
receiving first assistance information sent by a network side device based on a Control Plane (CP) or a User Plane (UP), and receiving and reordering the service data based on the first assistance information, wherein the first assistance information is configured to indicate a correspondence between a Sequence Number (SN) of a source transmission mode and an SN of the target transmission mode;
obtaining explicit or implicit first indication information, and establishing a multicast bearer from an SN initialization state based on the first indication information to continuously receive the service data;
obtaining explicit or implicit second indication information, and establishing a multicast bearer from an SN hold state based on the second indication information to continuously receive the service data; or
establishing an associated unicast bearer, and continuously receiving the service data based on the associated unicast bearer.

3. The method according to claim 2, wherein in a case that the first assistance information is sent based on the UP, the first assistance information is carried in a Layer 2 (L2) control Protocol Data Unit (PDU) or an L2 PDU header.

4. The method according to claim 1, wherein in a case that the source transmission mode is a PTM transmission mode, the continuously receiving service data further comprises:
establishing a multicast bearer based on the target transmission mode, maintaining an SN state of the target transmission mode the same as a Sequence Number (SN) state of the source transmission mode, and continuously receiving the service data.

5. The method according to claim 2, wherein the establishing an associated unicast bearer comprises:
in a case that the source transmission mode is switched to the target transmission mode, establishing the associated unicast bearer based on third indication information, wherein the third indication information is configured to indicate a target service for which the associated unicast bearer needs to be established.

6. The method according to claim 1, wherein in a case that the associated unicast bearer is established, the continuously receiving service data comprises at least one of the following:
sending service reception state information to the network side device by using the associated unicast bearer;
receiving first target data sent by the network side device, and reordering the first target data and received data; or
receiving a target Sequence Number (SN) correspondence sent by the network side device, and receiving and reordering the service data based on the target SN correspondence, wherein the target SN correspondence is a correspondence between the SN of the source transmission mode and the SN of the target transmission mode.

7. The method according to claim 1, wherein in a case that, the target transmission mode is a Point-To-Point (PTP) transmission mode, the continuously receiving service data comprises:
establishing a unicast bearer, and receiving multicast service data based on the unicast bearer, wherein a Sequence Number (SN) state of service data received in the target transmission mode is maintained based on an SN state of service data received in a source transmission mode; or
establishing an initialized unicast bearer, and receiving multicast service data based on the initialized unicast bearer, wherein an SN of service data received based on the target transmission mode is an initialized SN.

8. The method according to claim 1, wherein in a case that the target transmission mode is a Point-To-Point (PTP) transmission mode, and a Sequence Number (SN) state of service data received in the target transmission mode is maintained based on an SN state of service data received in a source transmission mode, the method further comprises:
reporting SN state information of received service data, wherein
the SN state information comprises at least one of service data that is successfully received and service data that fails to be received.

9. A data transmission method, performed by a network side device, wherein the method comprises:
sending configuration information of a target transmission mode of a multicast service to a terminal, wherein
the configuration information is used to instruct the terminal to continuously receive service data based on the target transmission mode.

10. The method according to claim 9, wherein in a case that the target transmission mode is a Point-To-Multipoint (PTM) transmission mode, the method further comprises any one of the following:
sending first assistance information to the terminal based on a Control Plane (CP) or a User Plane (UP), wherein the first assistance information is used to indicate a correspondence between a Sequence Number (SN) of a source transmission mode and an SN of the target transmission mode;
sending explicit or implicit first indication information, wherein the first indication information is used to instruct the terminal to establish a multi cast bearer from an SN initialization state to continuously receive the service data;
sending explicit or implicit second indication information, wherein the second indication information is used to instruct the terminal to establish a multicast bearer from an SN hold state to continuously receive the service data; or
sending third indication information, wherein the third indication information is used to instruct the terminal to establish an associated unicast bearer.

11. The method according to claim 10, wherein in a case that the first assistance information is sent based on the UP, the first assistance information is carried in a Layer 2 (L2) control Protocol Data Unit (MU) or an L2 PDU header.

12. The method according to claim 10, wherein the third indication information comprises at least one of the following:
a target service for which the associated unicast bearer needs to be established;
an SN difference between an SN of service data in the source transmission mode and an SN of service data in the target transmission mode; or
configuration information of the associated unicast bearer.

13. The method according to claim 10, wherein after the sending third indication information, the method further comprises at least one of the following:
receiving reception state information of multicast service data of the terminal; or
sending first target data to the terminal, wherein the first target data is multicast service data that fails to be received by the terminal.

14. The method according to claim 10, wherein in a case that the source transmission mode is a PTM transmission mode, the method further comprises at least one of the following:
receiving a mapping relationship between a Layer (L2) SN of service data sent by a source node in the source transmission mode and an SN of core network data, and determining an L2 SN of service data in the target transmission mode based on the mapping relationship, wherein the L2 SN of the service data in the target transmission mode is the same as the L2 SN of the service data in the source transmission mode; or
determining a service period or a service change period of a cell, wherein in a same service period or service change period, service data sent by a cell corresponding to the source transmission mode is the same as service data sent by a cell corresponding to the target transmission mode, or a same data packet carries a same L2 SN.

15. The method according to claim 14, wherein the mapping relationship between the L2 SN of the service data and the SN of the core network data is determined by using at least one of the following:
negotiation of an interface between network nodes;
stipulation in a protocol; or
a centralized control network node, wherein the centralized control network node is used to distribute data to another network node that accesses the centralized control network node.

16. The method according to claim 9, wherein in a case that the target transmission mode is a Point-To-Point (PTP) transmission mode, the method further comprises at least one of the following:
receiving Sequence Number (SN) state information of received service data that is reported the terminal, wherein the SN state information comprises at least one of service data that is successfully received and service data that fails to be received; or
sending second target data to the terminal, wherein the second target data is unicast service data that fails to be received by the terminal.

17. The method according to claim 9, wherein in a case that a target node corresponding to the target transmission mode is different from a source node corresponding to a source transmission mode, the method further comprises at least one of the following:
sending Sequence Number (SN) state transfer indication information to the source node, wherein the SN state transfer indication information is used to instruct the source node to perform SN state transfer on service data;
sending a data forwarding request to the source node, wherein the data forwarding request is used to instruct the source node to perform data forwarding;
receiving service data on which the source node performs data forwarding;
for service data corresponding to a Temporary Mobile Group Identifier (TMGI), receiving an upper limit of an SN value of service data that has been sent by the source node, wherein the SN is at least one of a Layer (L2) SN or an SN of a core network;
receiving SN information of service data that fails to be sent by the source node, wherein the SN is at least one of an L2 SN or an SN of a core network; or
receiving a correspondence between an L2 SN of service data of the source node and an SN of a core network.

18. The method according to claim 17, wherein the upper limit of the SN value is determined by using any one of the following:
an SN value of a last data packet sent by the source node on the TMGI before sending a mode switching request command to the terminal;
an SN value of a last data packet sent by the source node on the TMGI;
an SN value of a last data packet sent by the source node on the TMGI before sending a mode switching request command to the terminal and receiving an ACKnowledgement (ACK);
an SN value of a last data packet sent by the source node on the TMGI before performing SN state transfer; or
an SN value of any data packet sent by the source node on the TMGI.

19. A communications device, comprising:
a memory storing computer-readable instructions; and
a processor coupled to the memory and configured to execute the computer-readable instructions, wherein the computer-readable instructions, when executed by the processor, cause the processor to perform operations comprising:
receiving configuration information of a target transmission mode of a multicast service; and
continuously receiving service data based on the configuration information of the target transmission mode.

20. A communications device, comprising:
a memory storing computer-readable instructions; and
a processor coupled to the memory and configured to execute the computer-readable instructions, wherein the computer-readable instructions, when executed by the processor, cause the processor to perform the data transmission method according to claim 9.
